(19) United States
(12) Patent Application Publication
(10) Pub. No.: US 2018/0357683 A1
(43) Pub. Date: Dec. 13, 2018

(54) RATING DATA MANAGEMENT

(71) Applicant: International Business Machines Corporation, Armonk, NY (US)

(72) Inventors: Clifford A. Pickover, Yorktown Heights, NY (US); Komminist Weldemariam, Nairobi (KE)

(21) Appl. No.: 15/617,593

(22) Filed: Jun. 8, 2017

(51) Int. Cl. G06Q 30/02; G06N 99/00

(52) U.S. Cl. CPC G06Q 30/0282; G06N 99/005

(57) ABSTRACT

A rating transaction corresponding to a rating of a given subject obtained from a rating source is received. A rating logic program for validating the rating transaction based on one or more inputs is executed. A validity of the rating transaction is determined based at least in part on the execution of the rating logic program. In response to determining that the rating transaction is valid, a data block associated with the validated rating transaction is added to a secure chain of data blocks maintained at one or more computing nodes of a distributed network of computing nodes.

### BACKGROUND

Reviewing online ratings (i.e., reviews, likes, opinions, comments, blogs, social network postings), such as product or service ratings associated with electronic commerce (e-commerce) websites, has become an important aspect associated with consumer decision making. Online ratings may be a critical factor which influences an individual to purchase a product or service. For example, if most ratings for a product or service are positive, one is more likely to purchase the product or the service. However, if most ratings for a product or service are negative, one will most likely be deterred from purchasing the product or the service. Thus, in the age of e-commerce, it is imperative for companies to garner positive ratings of their products or services.

However, false, malicious and/or illegal ratings are becoming increasingly popular in order to mislead readers or automated systems (e.g., opinion mining and sentiment analysis systems). These false ratings may be disseminated by a human or computer program (e.g., a bot). For example, false positive ratings may be given in order to promote a product, service, company, etc., while false negative ratings may be given in order to damage the reputation of the product, service, company, etc. Additionally, product or service owners may pay individuals to rate or review their products or services. Determining the veracity or legitimacy of an online rating in the age of e-commerce is thus important in the protection of both consumers and companies offering products or services. Furthermore, since conventional online ratings databases are centrally controlled and maintained by product or service owners or a hosting organization on their behalf, these ratings may be modified or deleted by the product or service owners.

### SUMMARY

Embodiments provide techniques for managing data associated with a rating of a given subject, such as a rating of a product, a service, an individual, a business, etc.

In one embodiment, a method comprises the following steps. A rating transaction corresponding to a rating of a given subject obtained from a rating source is received. A rating logic program for validating the rating transaction based on one or more inputs is executed. A validity of the rating transaction is determined based at least in part on the execution of the rating logic program. In response to determining that the rating transaction is valid, a data block associated with the validated rating transaction is added to a secure chain of data blocks maintained at one or more computing nodes of a distributed network of computing nodes. The steps are implemented via at least one computing node of the distributed network of computing nodes comprising at least one processor operatively coupled to a memory.

In another embodiment, an apparatus comprises at least one processor and a memory operatively coupled to the processor to form a computing node of a distributed network of computing nodes. The processor and memory are configured to: receive a rating transaction corresponding to a rating of a given subject obtained from a rating source; execute a rating logic program for validating the rating transaction based on one or more inputs; determine a validity of the rating transaction based at least in part on the execution of the rating logic program; and wherein, in response to determining that the rating transaction is valid, a data block associated with the validated rating transaction is added to a secure chain of data blocks maintained at one or more computing nodes of a distributed network of computing nodes.

In yet another embodiment, a computer program product comprises a processor-readable storage medium having encoded therein executable code of one or more software programs. The one or more software programs when executed by the one or more processors implement steps of: receiving a rating transaction corresponding to a rating of a given subject obtained from a rating source; executing a rating logic program for validating the rating transaction based on one or more inputs; determining a validity of the rating transaction based at least in part on the execution of the rating logic program; and wherein, in response to determining that the rating transaction is valid, a data block associated with the validated rating transaction is added to a secure chain of data blocks maintained at one or more computing nodes of a distributed network of computing nodes.

Advantageously, illustrative embodiments provide effective management techniques for validating, storing and tracking rating data, such as, by way of example only, product or service rating data, in a distributed network by creating a secure (e.g., validated and protected) chain of data blocks representing transactions associated with the data. Events associated with ratings, such as, by way of example only, reviews, comments, etc. of products or services, may be detected, characterized, classified and stored on a trusted and immutable database. In this manner, consumers and companies have increased assurances that the product and service ratings are valid and trustworthy.

These and other exemplary embodiments of the invention will be described in or become apparent from the following detailed description of exemplary embodiments, which is to be read in connection with the accompanying drawings.

### BRIEF DESCRIPTION OF THE DRAWINGS

FIG. 1 illustrates a blockchain computational system with which one or more embodiments of the invention are implemented.

FIG. 2 illustrates a computing platform for managing data according to an embodiment of the invention.

FIG. 3 illustrates a blockchain for data according to an embodiment of the invention.

FIG. 4 illustrates a blockchain methodology for managing data according to an embodiment of the invention.

FIG. 5 illustrates a methodology for adding data to a blockchain that is used to track data according to an embodiment of the invention.

FIG. 6 depicts a computer system in accordance with which one or more components/steps of techniques of the invention may be implemented according to an embodiment of the invention.

FIG. 7 depicts a cloud computing environment according to an embodiment of the invention.

FIG. 8 depicts abstraction model layers according to an embodiment of the present invention.

### DETAILED DESCRIPTION

Illustrative embodiments will be described below for storing and tracking (more generally, managing) data associated with a rating of a subject. As used herein, the term “subject” (or “rating subject”) should be broadly construed to encompass anything or anyone that may be rated or otherwise evaluated, such as a product, a service, an individual, a business, etc. Thus, while illustrative techniques described herein are particularly well-suited for tracking product or service rating or evaluation data, it is to be understood that embodiments are not intended to be limited to such data. Furthermore, while “blockchain” technology will be described in one or more illustrative implementations, other types of data management technologies that generate a secure chain of data blocks maintained at computing nodes in a distributed network may be employed in one or more embodiments.

Prior to explaining the techniques for storing and tracking data associated with one or more e-commerce systems, a brief explanation of the blockchain technology will now be given.

Blockchain is the name given to a technology that enables creation of a digital ledger or record of transactions and sharing of this ledger or record among a distributed network of computers. Blockchain was originally developed as part of the bitcoin technology. Bitcoin is a digital asset and payment system. Blockchain technology uses cryptography to allow each participant on the network to manipulate the ledger in a secure way without the need for a central point of control. In the context of bitcoin, the blockchain technology maintains a public ledger of all bitcoin transactions that have previously occurred (i.e., a chain of transactions). In the bitcoin case, every compatible client is able to connect to the network, send new transactions to the network, verify transactions, and take part in the competition (called mining) to create new blocks. However, it is realized herein that blockchain technology can be adapted for other transactional applications to establish trust, accountability and transparency without requiring a central authority. Accordingly, blockchain technology is designed to provide tamper and revision resistance.

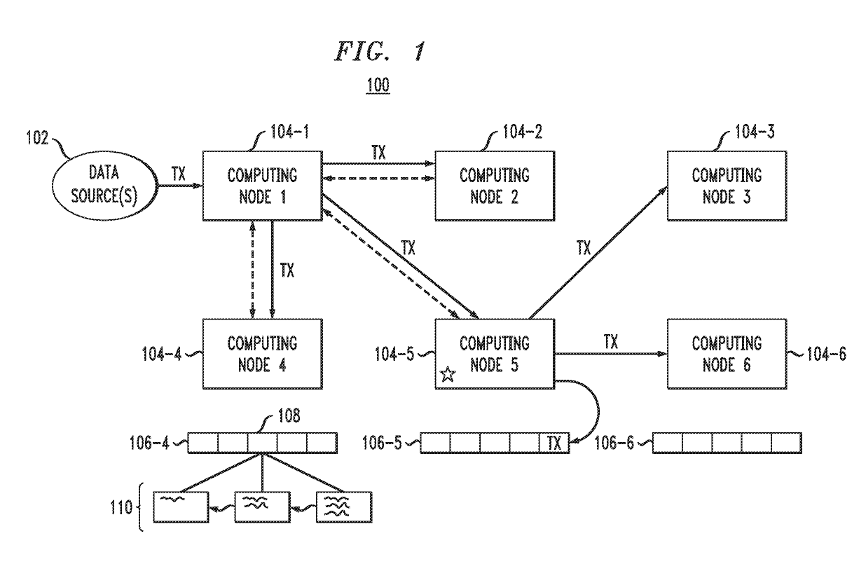

FIG. 1 illustrates a blockchain computational system 100 with which one or more embodiments of the invention may be implemented. As shown, the system 100 comprises one or more data sources 102 operatively coupled to at least one of a plurality of distributed peer computing nodes 104-1, 104-2, . . . , 104-6. The system 100 may have more or less computing nodes than the number illustrated in FIG. 1. Each computing node in the system 100 is configured to maintain a blockchain which is a cryptographically secured (via a cryptographic hash function) record or ledger of data blocks that represent respective transactions within some environment. A cryptographic hash function is a cryptographic function which takes an input (or “message”) and returns a fixed-size alphanumeric string, which is called the hash value (sometimes called a message digest, a digital fingerprint, a digest, or a checksum).

In FIG. 1, computing nodes 104-4, 104-5, and 104-6 are shown each maintaining the same blockchain (respectively illustrated as blockchains 106-4, 106-5, and 106-6). Although not expressly shown, each computing node in the system 100 is configured to be able to maintain this same blockchain. Each blockchain is a growing list of data records hardened against tampering and revision (i.e., secure). Each block in the blockchain (illustratively referenced as block 108 in blockchain 106-4) holds batches of one or more individual transactions and the results of any blockchain executables (e.g., computations that can be applied to the transactions). Each block typically contains a timestamp and information linking it to a previous block. More particularly, each subsequent block in the blockchain (e.g., 106-4, 106-5, 106-6, etc.) is a data block that includes a given transaction and a hash value of the previous block in the chain (i.e., the previous transaction). The current transaction and the hash value of the prior transactions can itself be hashed to generate a hash value. Thus, each data block in the blockchain represents a given set of transaction data plus a set of all previous transaction data (e.g., as illustratively depicted as 110 in FIG. 1).

Assume a new set of transaction data (new transaction TX) is obtained from one of the one or more data sources 102, and received by computing node 1 (104-1). Computing node 1 (104-1) can provide the new transaction TX to all or a subset of computing nodes in the system 100. In this case, TX is sent to computing node 2 (104-2), computing node 4 (104-4), and computing node 5 (104-5).

Note that computing node 104-5 is marked with a star symbol to denote it as a leader in a consensus protocol. That is, the computing nodes in the system 100 each are configured to participate in a consensus protocol as peers with one peer being designated as a leader. Any peer can assume the role of leader for a given iteration of the consensus protocol. In general, the leader receives all transactions from the participating peers in the system and creates a new block for the new transaction. The new block is sent out by the leader node to one or more of the other peer computing nodes (e.g., 104-3 and 104-6 as illustrated in FIG. 1) which double check (validate) that the leader computed the new block properly (i.e., the validating nodes agree by consensus). If consensus is reached, then the computing nodes in the system 100 add the new block to the blockchain they currently maintain. As a result, after the new transaction TX is processed by the system 100, each computing node should now have a copy of the same updated blockchain stored in its memory. Then, when a new transaction comes into the system 100, the above-described process of adding the transaction to the blockchain is repeated.

It is to be understood that any single computing node may itself serve as the receiver, validator, and block generator for of new transaction data set. However, in the context of a consensus protocol, the more nodes that validate the given transaction, the more trustworthy the data block is considered.

It is to be further understood that the above description represents one illustrative blockchain computation process and that embodiments of the invention are not limited to the above or any particular blockchain computation implementation. As such, other appropriate cryptographic processes may be used to maintain and add to a secure chain of data blocks in accordance with embodiments of the invention.

Illustrative embodiments adapt the blockchain computational system 100 of FIG. 1 to the management (e.g., storage and tracking) of data associated with one or more e-commerce systems. More particularly, as will be described in detail herein, non-limiting, illustrative embodiments adapt blockchain technology to product or service rating data associated with one or more e-commerce systems. Each product or service rating (or a rating of some other given subject) that is received by each computing node may be considered as a “transaction.”

The transactions may be compiled into a chain of product or service rating transaction blocks. In one embodiment, when a transaction is conducted, corresponding rating parameters are transmitted to one or more validation devices (e.g., computing nodes 104 in FIG. 1). These devices establish a validity of the transaction and generate a new block, as explained above. Once the new block has been calculated, it can be appended to the blockchain associated with the product or service. Thus, the blockchain may be considered to chronicle the ratings of a product or a service. Accordingly, blockchain technology is used to securely maintain data about such transactions (i.e., transaction data) to establish trust, accountability and transparency with regard to the product rating and evaluation data without requiring a central authority. As will be discussed herein, such techniques have wide ranging advantages for both consumers and companies.

Furthermore, as will be explained in detail herein, illustrative embodiments provide a blockchain computational system for implementing the above and other management features wherein each computing node comprises controller modules for managing transaction data and blockchain computation, as well as rating logic. More particularly, each computing node in the system is configured to store and track validated product and service ratings, as will be described in further detail herein.

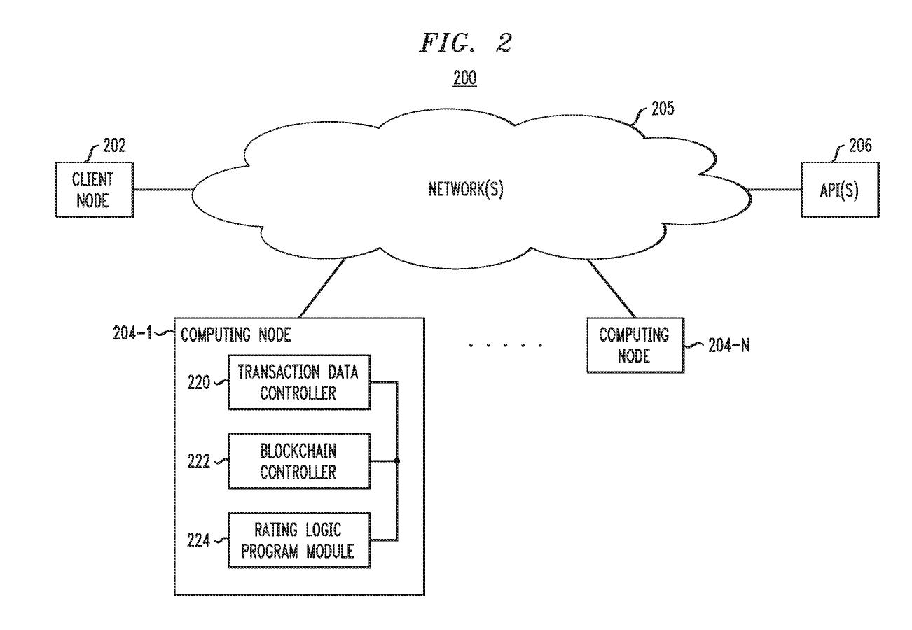

FIG. 2 illustrates a distributed computing platform 200 on which a blockchain computational system (such as system 100 in FIG. 1) can be implemented. More particularly, as shown, the distributed computing platform 200 includes one or more client nodes, including client node 202, and a plurality of computing nodes 204-1 through 204-N. In FIG. 2, one or more communication networks 205 operatively couple the client node 202 and the plurality of computing nodes 204-1 through 204-N. In one embodiment, communication network(s) 205 comprises a peer-to-peer (P2P) network, where each node is considered to be a peer. It is to be understood and appreciated that the distributed computing platform shown in FIG. 2 is purely illustrative, and that any number of components may be implemented in the distributed computing environment in accordance with the embodiments described herein.

In one embodiment, each client node comprises a client device. Exemplary client devices include, but are not limited to, personal computers, mobile devices (e.g., smartphones), tablets, etc. Each client node may be associated with one or more users. Each client node is configured to generate a rating transaction corresponding to a rating. Thus, each client node may be generally referred to as a “rating source.” In one embodiment, each rating transaction comprises product or service identification data, rating details, user identification data, and other metadata associated with the rating transaction. The other metadata may comprise, for example, location metadata and timestamp metadata. In one example, location metadata may comprise geographic information (e.g., town, city, state, country, or global positioning system (GPS) data) indicating where the particular rating was created, while timestamp metadata may comprise temporal information indicating when the particular rating was created. Further, other metadata may include data indicating that the product of the review was made through a verified purchase procedure, e.g., some e-commerce sites have procedures for providing an indication that a review was given by a purchaser that has been verified by the e-commerce site using some established verification procedure. Still further, other metadata may include data indicating that the review helped a given number of people, e.g., some e-commerce sites provide a field for enabling a reader of a review to indicate whether or not the review was helpful in their purchase decision.

For example, a user may generate a rating transaction corresponding to a rating of a subject via the Internet (e.g., by posting a rating on a website). In one embodiment, the rating is associated with a product or a service provided by an entity. For example, the entity may be associated with an e-commerce website through which a user may browse and purchase products and/or services provided by the entity. The e-commerce website may also have a section through which a user who has purchased a product or service may submit a product or service rating, respectively. The embodiments described herein are not limited to rating transactions corresponding to ratings generated on an e-commerce website. For example, a user may generate a rating via a social media account associated with the user, such as Facebook®, Twitter®, Pinterest®, etc., or another medium in accordance with the embodiments described herein. All of the data with respect to a given rating is considered transaction data in accordance with illustrative embodiments.

As will be described in greater detail below, at least one of the plurality of computing nodes 204-1 through 204-N is configured to receive a rating transaction from client node 202 or some other source. In one embodiment, the at least one computing node is further configured to broadcast the rating transaction to at least one of the other computing nodes designated to validate the rating transaction based on a validation protocol. Of course, if so configured, the initial receiving node may validate the rating transaction.

As further shown, FIG. 2 illustrates component details of the computing nodes. While the component details are representatively depicted for computing node 204-1, in one or more embodiments, each computing node may have such components. In alternative embodiments, a subset of the plurality of computing nodes have these components.

Thus, in the illustrative embodiment of FIG. 2, each computing node 204-1 is configured to include a transaction data controller 220, a blockchain controller 222, and rating logic program module 224. While functions of each controller and module will be described in greater detail below, in general: the transaction data controller 220 manages transaction data including, but not limited to, receiving or otherwise obtaining transaction data (e.g., product or service ratings); the blockchain controller 222 manages blockchain computation including, but not limited to, accessing the transaction data and generating a block and adding the block to a blockchain; and the rating logic program module 224 executes a logic for validating the rating transaction based on one or more inputs, and determines a validity of the rating transaction based at least in part on the execution of the logic. Thus, any number of nodes of the plurality of computing nodes 204-1 through 204-N may be configured to run the validating function of the logic program executed by the rating logic program module 224, in accordance with embodiments described herein. In one embodiment, the rating logic program comprises a blockchain chaincode program. The blockchain controller 222 may be configured to add a new data block associated with the rating transaction to a blockchain in response to the determination that the rating transaction is valid by the chaincode program.

The system of FIG. 2 may be configured to track sources of invalid ratings as part of the transaction in the blockchain for use in further analytics. Such a source may be a malicious person or a computer program (e.g., bot). Information about the malicious person or bot can be added to the blockchain as a transaction, in a similar manner as any other transaction described herein.

On top of providing trusted data, distributed computing platform 200 may provide for the implementation of various intelligent services, such as historic opinion trend of a product, historic sentiment of a product, etc. In one embodiment, and as shown in FIG. 2, these services may be available as built-in functions via one or more application programming interfaces (APIs) 206 for application developers. For example, the API(s) 206 may comprise one or more representational state transfer (RESTful) APIs. Examples of built-in functions available via API(s) 206 may include, but are not limited to: (1) CountRating (ID) configured to return a total number of ratings for a product identification (ID) (e.g., product name, serial number or barcode); (2) FakeRating (ID) configured to return a total number of fake ratings for a product ID, which may include a distribution of the fake ratings per region, area, etc.; (3) Sentiment (ID, TYPE) configured to return a summarized distribution of sentiments of a particular type (e.g., positive and negative) about the product ID from the blockchain (if no type is specified, it returns both positive and negative sentiments); (4) Feature (ID) configured to return a most popularly rated feature associated with the product ID; and (5) Cohort (ID, T) configured to return a cohort of product ID review for a duration period T (e.g., a week review, a month review, a year review). For example, security researchers may use these built-in functions to build spam detection services. Product or service specialists may use these built-in functions to derive new requirements or use cases for a product or service. Custom applications could use the built-in functions to integrate with applications, such as a recommendation application. These functions can be considered as metrics of opinion trend analysis and/or sentiment analysis associated with a given rating subject.

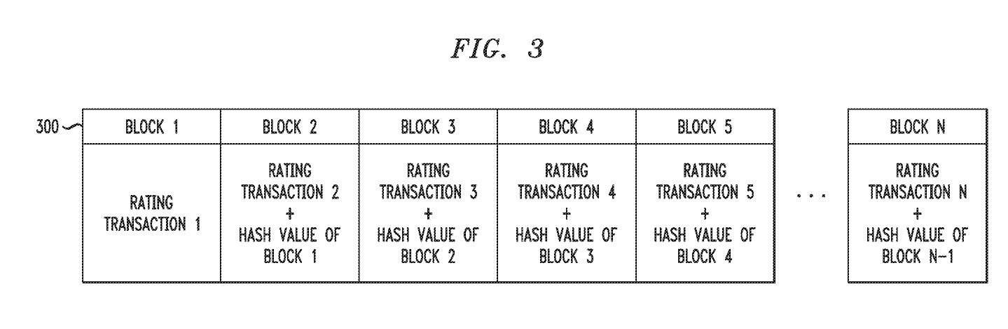

Given the above-described examples of transaction data (e.g., described in the context of FIGS. 1 and 2), FIG. 3 illustrates a blockchain 300 for rating transactions according to an embodiment of the invention. Each computing node in the computing platform 200 is configured to compute and store blockchain 300. As shown, each block (after block 1) includes a new transaction for the rating plus a hash value computed for the previous block. Thus, each data block in the blockchain represents a given set of transaction data plus a set of all previous transaction data, e.g., block N contains data for rating transaction N plus a hash value that represents all previous N-1 blocks. Alternatively, each block may contain a hash value of the combination of the new transaction for that block plus the hash value of the previous block. Alternative block content implementations may be employed in other embodiments.

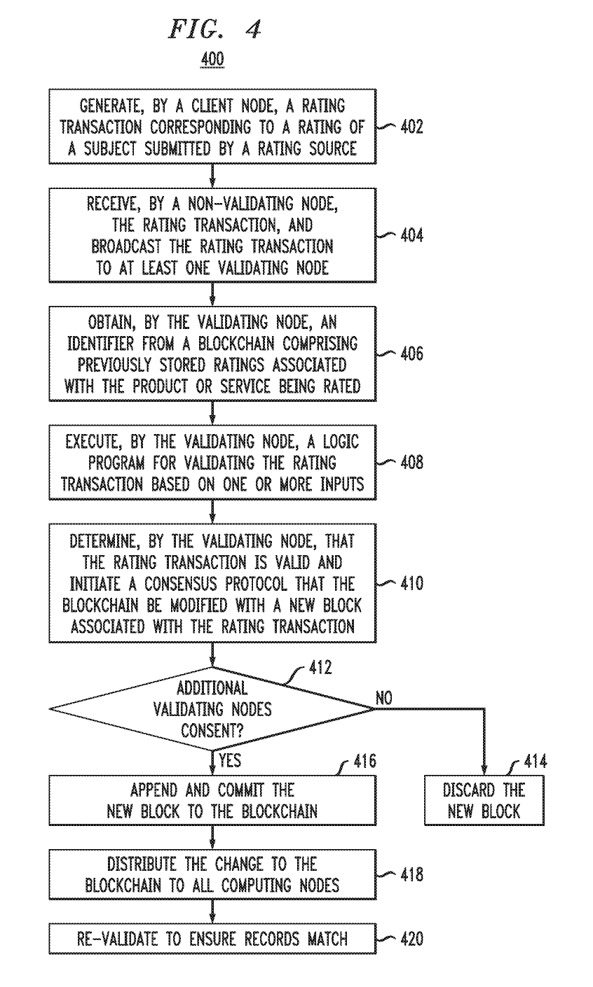

FIG. 4 illustrates a blockchain methodology 400 for validating and storing rating transactions, according to an embodiment of the invention. In this example, it is assumed that the initial computing node that receives the rating transaction is a non-validating node, which then provides the rating transaction to one or more validating nodes. However, as mentioned herein, each computing node can be configured to validate a received rating transaction.

At step 402, a rating transaction corresponding to a rating of a subject is generated by a rating source. In one embodiment, the rating source is generated by a client (i.e., user) node of a distributed network of nodes. The rating transaction may include data such as product or service identification, rating content, user identification, and other metadata. For example, other metadata may include location metadata and timestamp metadata. In one embodiment, generating the rating transaction comprises signing and encrypting the rating transaction using a private key. At step 404, the rating transaction is received by a non-validating node of the distributed network of nodes, and the rating transaction is broadcast to at least one validating node of the distributed network of nodes. At step 406, the validating node obtains an identifier from a blockchain comprising previously stored ratings associated with the subject being rated. Note that each rating transaction may be assigned a unique identifier. The identifier may be unique among all transactions in the rating system, or simply unique as to the given rating subject (e.g., product or service).

At step 408, the validating node executes a rating logic program for validating the rating transaction based on one or more inputs. The rating logic program is the business logic of a rating process to which participating entities agree upon (e.g., providers of products and/or services). In one embodiment, the one or more inputs comprise a rating payload (e.g., the rating information obtained from the rating source such as, by way of example only, a review or evaluation of a product or service) and one or more historical rating transactions (e.g., past rating transactions associated with the product or service).

In one embodiment, the logic program comprises a chaincode program that, when executed, performs one or more chaincode functions for validating the rating transaction. For example, the one or more chaincode functions may include a chaincode function for detecting and characterizing the rating transaction using content of the rating payload. The one or more chaincode functions may further include a chaincode function for determining that the rating transaction comprises sufficient information (e.g., that all mandatory elements of a rating transaction, such as product identification, rating content user identification and other metadata, are complete). The one or more chaincode functions may further include a chaincode function for generating one or more outputs to be included in a new data block of the secure chain of data blocks (e.g., blockchain), such as a review token indicating a malicious or benign rating, basic statistics information (e.g., counting information), etc.

The one or more chaincode functions may further include a chaincode function for assessing a reputation of a source of the rating (e.g., user) using one or more machine learning algorithms to analyze data associated with the source of the rating. In one embodiment, the data associated with the source of the rating includes one or more of source identification, time of posting, and frequency of posting. The data used to assess the reputation of the source of the rating may include, for example, crowdsourced data, social media data, and other public data. However, the data associated with the source of the rating should not be limited and may include any data considered to be relevant in the context of assessing source reputation.

In one embodiment, executing the rating logic program further comprises employing one or more algorithms for determining whether the rating transaction is invalid. For example, the one or more algorithms may be employed to analyze a corpus of ratings databases. The corpus of ratings databases may comprise one or more online databases, one or more offline databases, or combinations thereof. The one or more algorithms may include one or more of a text analytic algorithm, a cluster method a similarity method, a summarization method, a supervised learning algorithm, a pattern discovery algorithm, a graph-based algorithm, or any algorithm that may be used to in determining whether the rating transaction is invalid. The one or more algorithms may analyze one or more of textual content of the rating, content and style similarity of ratings from one or more sources of ratings, semantic inconsistency, relationships among the ratings sources and the entity associated with the product or service being rated, features related to the product or service (e.g., description, sales volume and sales rank), etc. It is to be understood and appreciated that these algorithms are purely exemplary, and that other algorithms may be used to determine rating transaction validity and/or invalidity in accordance with the embodiments described herein.

In one embodiment, the logic program updates an invalidity counter associated with a number of invalid ratings relating to the product or service being rated if the one or more algorithms determine that the rating transaction is invalid.

At step 410, the validating node determines that the rating transaction is valid and initiates a consensus protocol that the blockchain be modified with a new block containing the rating transaction. In one embodiment, initiating the consensus protocol comprises generating a proposal that the blockchain be modified with a new data block associated with the rating transaction, and transmitting the proposal to one or more additional validating nodes of the distributed network of nodes. At step 412, it is determined whether the additional validating nodes have consented. If not, the new block is discarded at step 414. If the additional validating nodes have consented, the new block is appended and committed to the blockchain at step 416. At step 418, the change to the block chain is distributed to all the computing nodes of the distributed network of computing nodes (as well as, for example, computing nodes associated with entities providing the product or service), and at step 420, a re-validation is performed to ensure the records of each computing node match.

It is to be appreciated that each step of methodology 400 can be performed at the same computing node or the one or more steps can be separately performed at different computing nodes. That is, depending on the consensus protocol used (assuming one is used), the steps are distributively performed across the computing platform 200 or within each computing node. The result is that each computing node preferably maintains the same updated blockchain.

Illustrative embodiments described herein may be used to help create a permanent and unbreakable link between the author of a rating and the rating itself, since the record of ownership can be forever verified and tracked. Illustrative embodiments described herein may be used to facilitate the secure sharing of a reviewer's digital content with friends, family, fans, etc. For example, a rating may be disseminated easily via e-mail. Illustrative embodiments described herein may be used to aid in tracking where and how a rating spreads on the Internet. For example, growth of a rating may be tracked and displayed over time via the blockchain. Each registered rating may be associated with a verifiable certificate of authenticity, which may include a built-in unique cryptographic identification and complete ownership history. Illustrative embodiments described herein may help users license, consign, loan, or otherwise transfer their content to third parties without losing attribution.

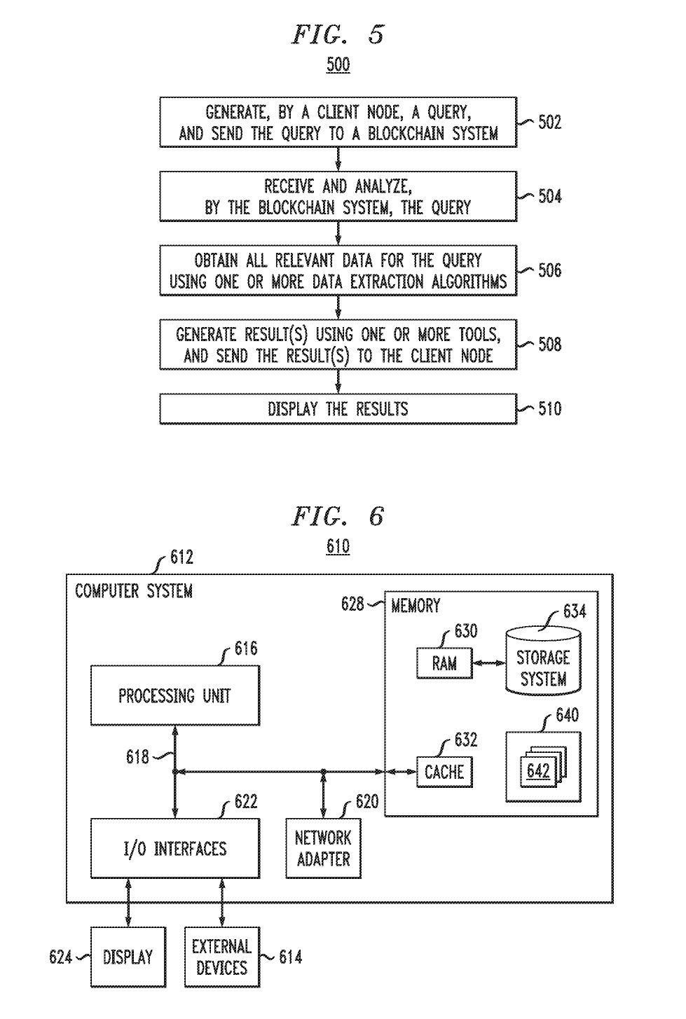

FIG. 5 illustrates a methodology 500 for providing a query service associated with a blockchain, according to an embodiment of the present invention. As shown, in step 502, a client device or some other source (e.g., a system administrator, etc.) generates a query and sends the query to a blockchain system. In one embodiment, the query is configured to obtain data associated with a blockchain of the blockchain system. For example, the query may comprise one or more of a count rating query, a fake rating query, a sentiment query, a feature query and a cohort query. At step 504, the blockchain system receives and analyzes the query. At step 506, the data associated with the blockchain is obtained using one or more (intelligent) data extraction algorithms. At step 508, one or more results are generated using one or more tools, and the one or more results are sent to the client device in satisfaction of the query. In one embodiment, the one or more tools include one or more analytic algorithms and one or more application programming interfaces (APIs). For example, the one or more APIs may include a sentiment API, and the one or more results may include a sentiment. At step 510, the results are displayed on a dashboard at the client device.

Among many advantages that are realized through the blockchain computational system described herein, some of the key advantages include: eliminating invalid product or service ratings, such as fake, malicious, illegal or otherwise untrustworthy product or service ratings; tracking product and service ratings in a transparent, secure and immutable manner by validating the ratings through a consensus protocol; and supporting built-in services or capabilities using application programming interfaces.

One or more embodiments can make use of software running on a computer or workstation. With reference to FIG. 6, in a node 610 there is a system/server 612, which is operational with numerous other general purpose or special purpose computing system environments or configurations. Examples of well-known computing systems, environments, and/or configurations that may be suitable for use with system/server 612 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each node in the computing platform 200 can implement the architecture shown in node 610.

System/server 612 may be described in the general context of computer system executable instructions, such as program modules, being executed by a computer system. Generally, program modules may include routines, programs, objects, components, logic, data structures, and so on that perform particular tasks or implement particular abstract data types. System/server 612 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, system/server 612 is shown in the form of a computing device. The components of system/server 612 may include, but are not limited to, one or more processors or processing units 616, system memory 628, and bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

System/server 612 typically includes a variety of computer system readable media. Such media may be any available media that is accessible by system/server 612, and it includes both volatile and non-volatile media, removable and non-removable media.

The system memory 628 can include computer system readable media in the form of volatile memory, such as random access memory (RAM) 630 and/or cache memory 632. System/server 612 may further include other removable/non-removable, volatile/nonvolatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces.

As depicted and described herein, memory 628 may include at least one program product having a set (e.g., at least one) of program modules that are configured to carry out the functions of embodiments of the invention. A program/utility 640, having a set (at least one) of program modules 642, may be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 642 generally carry out the functions and/or methodologies of embodiments of the invention as described herein.

System/server 612 may also communicate with one or more external devices 614 such as a keyboard, a pointing device, an external data storage device (e.g., a USB drive), display 624, one or more devices that enable a user to interact with system/server 612, and/or any devices (e.g., network card, modem, etc.) that enable system/server 612 to communicate with one or more other computing devices. Such communication can occur via I/O interfaces 622. Still yet, system/server 612 can communicate with one or more networks such as a LAN, a general WAN, and/or a public network (e.g., the Internet) via network adapter 620. As depicted, network adapter 620 communicates with the other components of system/server 612 via bus 618. It should be understood that although not shown, other hardware and/or software components could be used in conjunction with system/server 612. Examples include, but are not limited to, microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

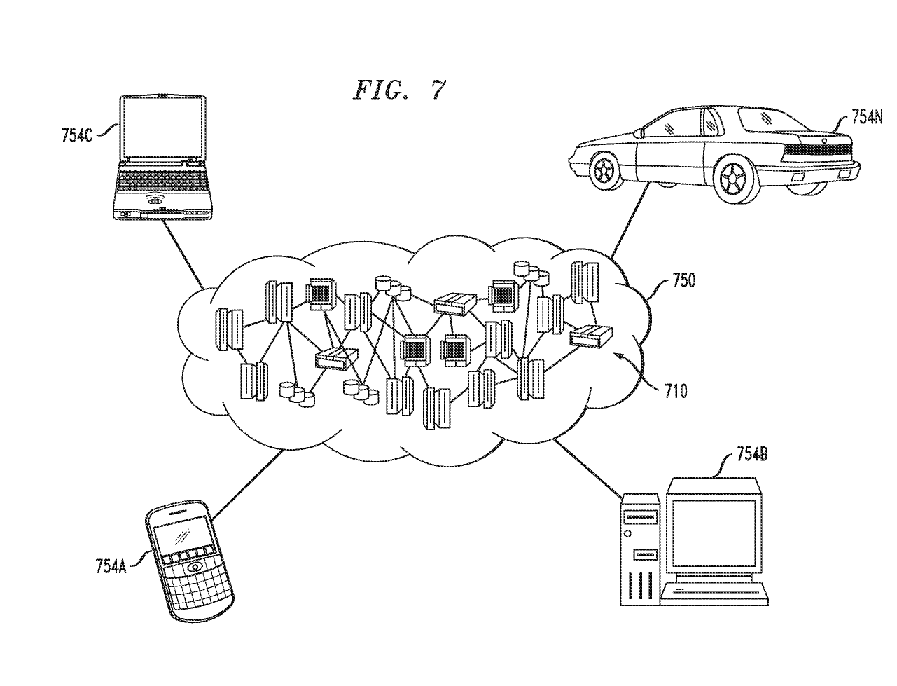

Referring now to FIG. 7, illustrative cloud computing environment 750 is depicted. As shown, cloud computing environment 750 includes one or more cloud computing nodes 710 with which local computing devices used by cloud consumers, such as, for example, personal digital assistant (PDA) or cellular telephone 754A, desktop computer 754B, laptop computer 754C, and/or automobile computer system 754N may communicate. Nodes 710 may communicate with one another. They may be grouped (not shown) physically or virtually, in one or more networks, such as Private, Community, Public, or Hybrid clouds as described hereinabove, or a combination thereof. This allows cloud computing environment 750 to offer infrastructure, platforms and/or software as services for which a cloud consumer does not need to maintain resources on a local computing device. It is understood that the types of computing devices 754A-N shown in FIG. 7 are intended to be illustrative only and that computing nodes 710 and cloud computing environment 750 can communicate with any type of computerized device over any type of network and/or network addressable connection (e.g., using a web browser).

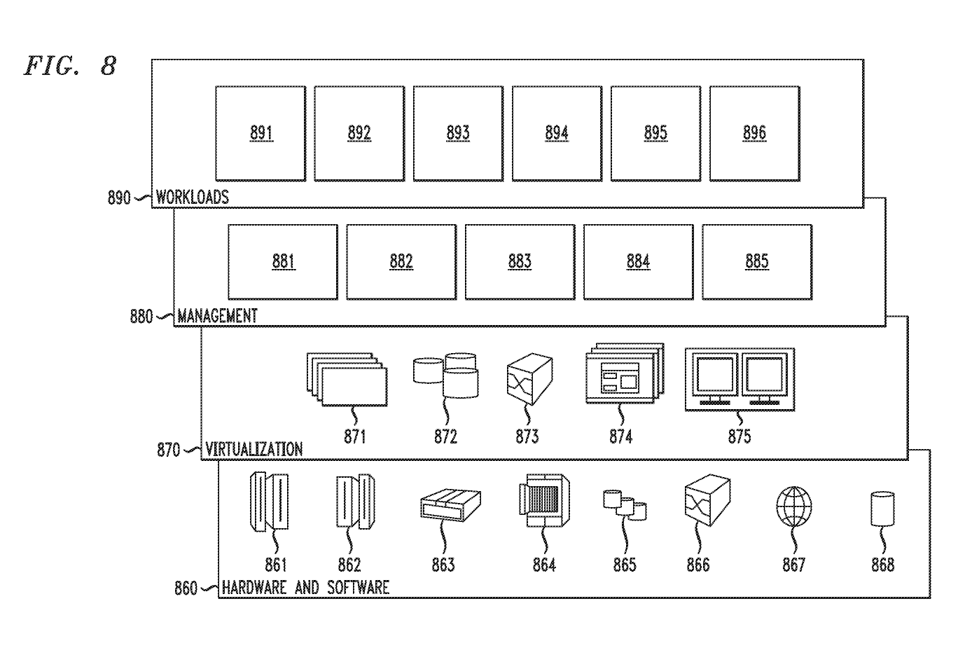

Referring now to FIG. 8, a set of functional abstraction layers provided by cloud computing environment 750 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 860 includes hardware and software components. Examples of hardware components include: mainframes 861; RISC (Reduced Instruction Set Computer) architecture based servers 862; servers 863; blade servers 864; storage devices 865; and networks and networking components 866. In some embodiments, software components include network application server software 867 and database software 868.

Virtualization layer 870 provides an abstraction layer from which the following examples of virtual entities may be provided: virtual servers 871; virtual storage 872; virtual networks 873, including virtual private networks; virtual applications and operating systems 874; and virtual clients 875.

In one example, management layer 880 may provide the functions described below. Resource provisioning 881 provides dynamic procurement of computing resources and other resources that are utilized to perform tasks within the cloud computing environment. Metering and Pricing 882 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 883 provides access to the cloud computing environment for consumers and system administrators. Service level management 884 provides cloud computing resource allocation and management such that required service levels are met. Service Level Agreement (SLA) planning and fulfillment 885 provide pre-arrangement for, and procurement of, cloud computing resources for which a future requirement is anticipated in accordance with an SLA.

Workloads layer 890 provides examples of functionality for which the cloud computing environment may be utilized. Examples of workloads and functions which may be provided from this layer include: transaction data capture 891; blockchain computation 892; data analytics processing 893; transaction validity assessment 894; consensus processing 895; and blockchain modification 896, which may perform various functions described above.

Embodiments of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although illustrative embodiments have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method, comprising:
receiving a rating transaction corresponding to a rating of a given subject obtained from a rating source;
executing a rating logic program for validating the rating transaction based on one or more inputs; and
determining a validity of the rating transaction based at least in part on the execution of the rating logic program;
wherein, in response to determining that the rating transaction is valid, a data block associated with the validated rating transaction is added to a secure chain of data blocks maintained at one or more computing nodes of a distributed network of computing nodes; and
wherein the steps are implemented via at least one computing node of the distributed network of computing nodes comprising at least one processor operatively coupled to a memory.

2. The method of claim 1, wherein the given rating subject is at least one of a product, a service, an individual, and a business.

3. The method of claim 1, wherein the rating source is associated with a client node operatively coupled to the distributed network of computing nodes.

4. The method of claim 1, wherein each rating transaction comprises one or more of rating subject identification data, rating details, user identification data, and other metadata associated with the rating transaction.

5. The method of claim 4, wherein the other metadata associated with the rating transaction comprises one or more of location metadata and timestamp metadata.

6. The method of claim 1, wherein the one or more inputs comprise a rating payload and the one or more historical rating transactions.

7. The method of claim 1, wherein executing the rating logic program further comprises detecting and characterizing the rating transaction based on the rating payload.

8. The method of claim 1, wherein executing the rating logic program further comprises determining that the rating transaction comprises information sufficient to determine validity of the rating transaction.

9. The method of claim 1, wherein executing the rating logic program further comprises executing one or more algorithms for determining whether the rating transaction is valid by analyzing a corpus of one or more rating databases.

10. The method of claim 9, wherein the one or more algorithms comprise one or more of a text analytic algorithm, a cluster method, a similarity method, a summarization method, a supervised learning algorithm, a pattern discovery algorithm, and a graph-based algorithm.

11. The method of claim 9, wherein the one or more algorithms analyze one or more of a rating textual content, an algorithm for computing content and style similarity of ratings from one or more sources of ratings, an algorithm for computing semantic inconsistency, an algorithm for computing relationships among the one or more sources of ratings and the entity, an algorithm for computing features related to the rating subject.

12. The method of claim 1, wherein executing the rating logic program further comprises updating an invalidity counter associated with a number of invalid ratings.

13. The method of claim 1, wherein executing the rating logic program further comprises assessing a reputation of the source of the rating using one or more machine learning algorithms to analyze data associated with the reputation of the source of the rating.

14. The method of claim 13, wherein the data associated with the source of the rating comprises one or more of source identification, a time of posting, and a frequency of posting.

15. The method of claim 13, wherein the data associated with the reputation of the source of the rating comprises one or more of crowdsourced data, social media data, and other public data.

16. The method of claim 1, further comprising initiating a consensus protocol to add the data block to the secure chain of data blocks, wherein initiating the consensus protocol comprises:
generating a proposal that the secure chain of data blocks be modified with a data block associated with the rating transaction; and
transmitting the proposal to one or more additional computing nodes of the distributed network of computing nodes;
wherein the data block is added to the secure chain of data blocks upon receiving a consensus from the one or more additional computing nodes by computing the data block, and appending and committing the computed data block to the secure chain of data blocks.

17. The method of claim 1, wherein the secure chain of data blocks is associated with one or more functions available via one or more application programming interfaces.

18. The method of claim 17, wherein the one or more functions comprise one or more metrics of at least one of opinion trend analysis and sentiment analysis.

19. An apparatus, comprising:
at least one processor; and
a memory operatively coupled to the processor to form a computing node of a distributed network of computing nodes, wherein the processor and memory are configured to:
receive a rating transaction corresponding to a rating of a given subject obtained from a rating source;
execute a rating logic program for validating the rating transaction based on one or more inputs; and
determine a validity of the rating transaction based at least in part on the execution of the rating logic program;
wherein, in response to determining that the rating transaction is valid, a data block associated with the validated rating transaction is added to a secure chain of data blocks maintained at one or more computing nodes of a distributed network of computing nodes.

20. A computer program product comprising a processor-readable storage medium having encoded therein executable code of one or more software programs, wherein the one or more software programs when executed by the one or more processors implement steps of:
receiving a rating transaction corresponding to a rating of a given subject obtained from a rating source;
executing a rating logic program for validating the rating transaction based on one or more inputs; and
determining a validity of the rating transaction based at least in part on the execution of the rating logic program;
wherein, in response to determining that the rating transaction is valid, a data block associated with the validated rating transaction is added to a secure chain of data blocks maintained at one or more computing nodes of a distributed network of computing nodes.
